(19) United States
(12) Patent Application Publication
(10) Pub. No.: US 2012/0062936 A1
(43) Pub. Date: Mar. 15, 2012

(54) PRINTER, COMPUTER READABLE MEDIUM, AND METHOD

(75) Inventor: Yoshiyuki NAKAJIMA, Kanagawa (JP)

(73) Assignee: FUJI XEROX CO., LTD., Tokyo (JP)

(21) Appl. No.: 13/017,743

(22) Filed: Jan. 31, 2011

(30) Foreign Application Priority Data
Sep. 9, 2010 (JP) 2010-202206

(51) Int. Cl. G06F 3/12

(52) U.S. Cl. 358/1.15

(57) ABSTRACT

A printer includes an output unit, a management unit, and a transmission unit. The output unit outputs an image onto print paper. The management unit monitors an operating state of the output unit, and manages operating state information. The transmission unit transmits managed operating state information in response to an operating state acquisition request from a host device. Upon receipt of a request for obtaining operating state information from the host device, if the printer is set as a first device in tandem operation, the transmission unit does not transmit the operating state information to the host device. If the printer is set as a second device in tandem operation, the transmission unit transmits the managed operating state information including operating state information on the printer and operating state information on the first device to the host device.

### CROSS-REFERENCE TO RELATED APPLICATIONS

This application is based on and claims priority under 35 USC 119 from Japanese Patent Application No. 2010-202206 filed Sep. 9, 2010.

### BACKGROUND

### Technical Field

The present invention relates to a printer, a computer readable medium storing a program, and a method.

### SUMMARY

According to an aspect of the invention, there is provided a printer including an output unit, a management unit, and a transmission unit. The output unit outputs an image onto print paper. The management unit monitors an operating state of the output unit, and manages operating state information. The transmission unit transmits operating state information managed by the management unit in response to an operating state acquisition request from a host device. Upon receipt of a request for obtaining operating state information from the host device, if the printer is set as a first device in tandem operation, the transmission unit does not transmit the operating state information to the host device. If the printer is set as a second device in tandem operation, the transmission unit transmits operating state information on the printer and operating state information on the first device to the host device, the operating state information on the printer and the operating state information on the first device being managed by the management unit.

### BRIEF DESCRIPTION OF THE DRAWINGS

Exemplary embodiment(s) of the present invention will be described in detail based on the following figures, wherein:

FIG. 1 illustrates the system configuration of a printing system according to an exemplary embodiment of the present invention;

FIG. 2 is a block diagram illustrating the hardware configuration of a printer according to an exemplary embodiment of the present invention;

FIG. 3 is a block diagram illustrating the functional configuration of a printer according to an exemplary embodiment of the present invention;

FIG. 4 illustrates the operation of printers when one of the printers operates as an upstream machine and the other printer 10b operates as a downstream machine;

FIG. 5 is a flowchart illustrating an initial setting operation of printers in a printing system according to an exemplary embodiment of the present invention;

FIG. 6 is a sequence chart illustrating an initial setting operation performed between an upstream machine and a downstream machine;

FIG. 7 is a flowchart illustrating the operation of a state monitoring unit;

FIG. 8 is a flowchart illustrating the operation of a management unit;

FIG. 9 illustrates the configuration of status information on a given device and status information on a downstream machine that the given device returns to a high-level host device;

FIGS. 10A and 10B illustrate specific examples of status information on a given device and status information on a downstream machine that the given device returns to the high-level host device;

FIG. 11 illustrates the configuration of merged status information; and

FIGS. 12A and 12B illustrate specific examples of the merged status information.

### DETAILED DESCRIPTION

To help understand the present invention, there will first be described its background and overview.

A tandem printing system including two printers may be used for duplex printing on continuous paper. The tandem printing system allows high-speed duplex printing on continuous paper by continuously performing obverse-side printing and reverse-side printing using the two printers. This type of tandem printing system is configured to perform, for example, printing on the obverse side followed by the reverse side of continuous paper, and the printer responsible for obverse-side printing is called an upstream machine, and the printer responsible for reverse-side printing is called a downstream machine.

The term “tandem operation”, as used herein, refers to an operation in which two printers separately perform printing on the obverse and reverse sides of paper. Furthermore, one of the two printers that receives print data from a high-level host device is defined as an upper device, and the other printer that receives print data from the upper device is defined as a lower device. Additionally, one of the upper device and the lower device is defined as a first device and the other is defined as a second device.

In the operation of the above tandem printing system, the high-level host device that manages a printing operation generally performs operations such as checking the progress of a print job (printing instruction) that is currently being executed and managing the operating state of the printing system. In some printing systems, a single high-level host device manages multiple printers.

In the printing system as described above, in order to manage the operating state of a printer and the process status of a print job, plural printers, a high-level host device, and other suitable devices may be connected to one another via a network so that the high-level host device manages the operating state of individual printers and the process status of print jobs.

With the recent widespread use of Transmission Control Protocol/Internet Protocol (TCP/IP) as a network communication protocol, the high-level host device and the plural printers described above may be connected via a network based on such a communication protocol.

In TCP/IP, Simple Network Management Protocol (SNMP) is used for network management. The SNMP allows operating states and the like to be monitored using information having a preset structure called Management Information Base (MIB). MIB is information made available to the public by a network device managed using SNMP to notify an external device of the operating state of the network device. With the use of MIB information, it is possible to monitor the operating state of a printer and the process status of a print job.

The MIB information includes information for monitoring the operating state of a printer, and information for monitoring the process status of a print job. A high-level host device is capable of knowing the operating state of a printer by using MIB information for monitoring the operating state of the printer, and is capable of obtaining information such as the progress of a print job by using MIB information for monitoring the process status of the print job.

Further, the high-level host device transmits a print job to a printer set as the upstream machine, and the printer serving as the upstream machine transfers data to be printed on the print side to a printer serving as the downstream machine. No need exists for the high-level host device to have knowledge of which two printers are arranged in a tandem configuration. Therefore, the high-level host device is not informed of configuration information about a printer or printers even if a printer operates alone (or performs a “single-mode operation”) or two printers operate in tandem to implement a tandem printing system in accordance with the print job to be executed.

The high-level host device has no knowledge of information such as which printers are performing a tandem operation, which printer is performing a single-mode operation, and which two printers form a tandem printing system. Thus, in a case where two printers are in tandem operation, inconvenience may occur if each of plural printers reports the process status of a print job that the printer is currently processing to the high-level host device to allow the high-level host device to monitor the operating state and the like of the plural printers using MIB information.

Specifically, when the high-level host device queries each of plural printers connected to a network about the process status of a print job that the printer is currently processing, monitoring results indicating that the same print job is currently being executed may be obtained from two printers operating in tandem, and the obtained results may conflict with each other. That is, although the high-level host device has transmitted a print job to only the printer operating as the upstream machine, a monitoring result indicating that the print job is currently being executed may be obtained from the downstream machine to which the high-level host device has not transmitted the print job. Thus, the high-level host device that does not hold information regarding the tandem configuration may observe inconsistency in the obtained monitoring result.

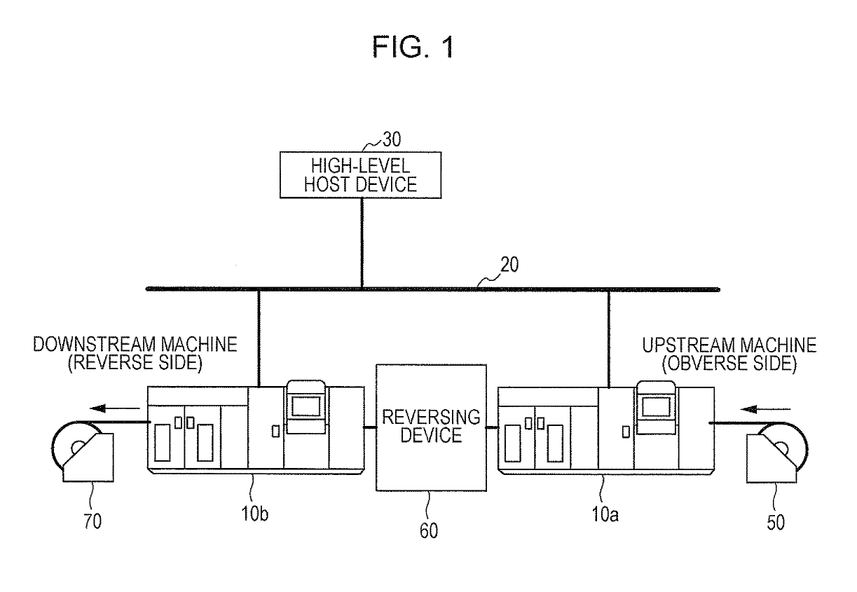

Next, exemplary embodiments of the present invention will be described in detail with reference to the drawings. FIG. 1 illustrates the system configuration of a printing system according to an exemplary embodiment of the present invention.

As illustrated in FIG. 1, a printing system according to an exemplary embodiment of the present invention includes two printers 10a and 10b, a high-level host device 30 configured to manage and control the operation of the printers 10a and 10b, a pre-processor 50, a reversing device 60, and a post-processor 70. The printers 10a and 10b and the high-level host device 30 are connected to each other via a network 20. In this exemplary embodiment, only two printers 10a and 10b are illustrated for ease of description; however, other printers which are not illustrated in FIG. 1 are also connected to the network 20.

The printing system according to this exemplary embodiment may be a tandem printing system in which the printer 10a that performs printing processing on the obverse side of continuous paper and the printer 10b that performs printing processing on the reverse side of the continuous paper that has been subjected to printing by the printer 10a are connected in a tandem configuration so that the printing processing is performed on the obverse and reverse sides of the continuous paper.

In this exemplary embodiment, by way of example, printing on the obverse side followed by the reverse side of continuous paper is performed. Thus, the printer 10a is referred to as an “upstream machine” (upstream printer), and the printer 10b is referred to as a “downstream machine” (downstream printer).

The high-level host device 30 generates print data in accordance with a print job (printing instruction), and transmits the generated print job to the printer 10a set as the upstream machine via the network 20. The printer 10a set as the upstream machine transmits reverse-side print data to the printer 10b set as the downstream machine via the network 20.

In this exemplary embodiment, a description will be given of a case where the upstream machine that first performs printing on continuous paper functions as an upper device configured to perform operations such as managing print jobs and transmitting status information to the high-level host device 30. In this case, the downstream machine functions as a lower device configured to execute printing processing in accordance with print data received from the upper device and to transmit its operating state to the upper device as status information.

Next, the configuration of the printers 10a and 10b will be described. Since the printers 10a and 10b have basically similar configurations, the description will be given in the context of the printer 10a.

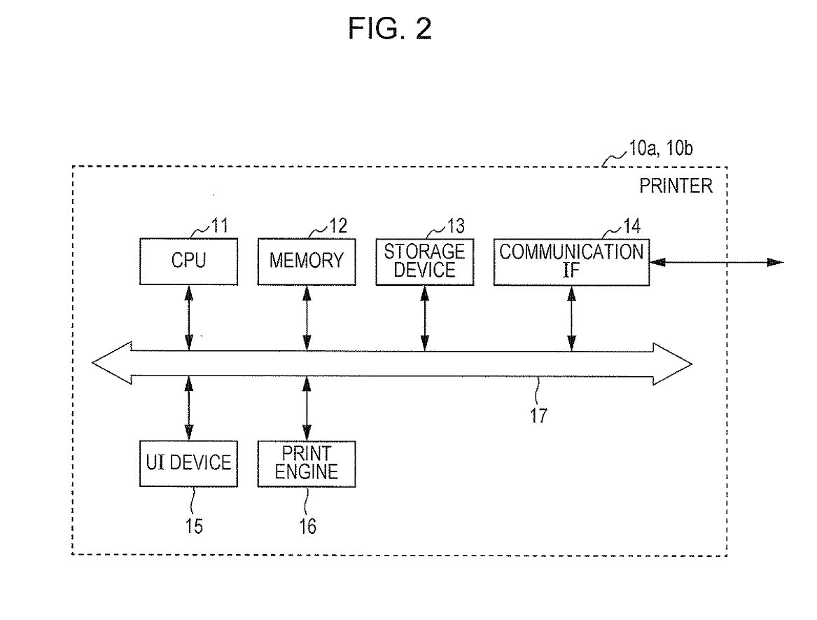

FIG. 2 illustrates the hardware configuration of the printer 10a (10b) in the printing system according to this exemplary embodiment.

As illustrated in FIG. 2, the printer 10a (10b) includes a central processing unit (CPU) 11, a memory 12, a storage device 13 such as a hard disk drive (HDD), a communication interface (IF) 14 that transmits and receives data to and from an external device or the like via the network 20, a user interface (UI) device 15 including a touch panel or a liquid crystal display and a keyboard, and a print engine 16. The above components are connected to one another via a control bus 17.

The CPU 11 executes a predetermined process in accordance with a control program stored in the memory 12 or the storage device 13, and controls the operation of the printer 10a (10b). In this exemplary embodiment, a description has been given of a case where the CPU 11 reads the control program stored in the memory 12 or the storage device 13 and executes the control program. However, the program may also be stored in a storage medium such as a compact disc read only memory (CD-ROM) and provided to the CPU 11.

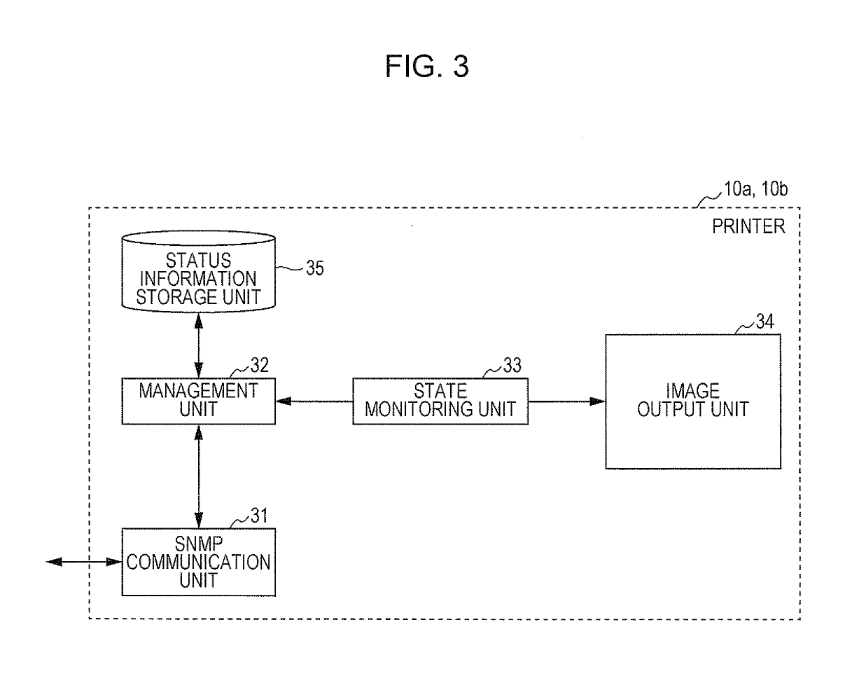

FIG. 3 is a block diagram illustrating the functional configuration of the printer 10a (10b) that is implemented by the execution of the control program described above.

As illustrated in FIG. 3, the printer 10a (10b) according to this exemplary embodiment includes an SNMP communication unit 31, a management unit 32, a state monitoring unit 33, an image output unit 34, and a status information storage unit 35.

The image output unit 34 outputs an image onto print paper such as continuous paper.

The state monitoring unit 33 monitors the operating state of the image output unit 34, and obtains status (operating state) information. Specific examples of the status information include information indicating that the printing operation of the image output unit 34 is normal, information indicating that the printing operation is suspended due to paper jam, and information indicating that a consumable has been exhausted, such as out-of-toner information or out-of-paper information. When the printer 10a (10b) is set as the downstream machine in tandem operation, the state monitoring unit 33 transfers the obtained status information to the upstream machine in tandem operation. When the printer 10a (10b) is set as the upstream machine in tandem operation or is set to perform a single-mode operation, the state monitoring unit 33 transmits the obtained status information to only the management unit 32 of the printer 10a (10b).

The SNMP communication unit 31 communicates with another printer, the high-level host device 30, and the like via the network 20 in accordance with the SNMP protocol. Specifically, the SNMP communication unit 31 receives a status acquisition request (a request for obtaining operating state information) from the high-level host device 30, or transmits status information to the high-level host device 30 as MIB information.

The management unit 32 stores the status information obtained by the state monitoring unit 33 in the status information storage unit 35 for management. If the printer 10a (10b) is set as the upstream machine in tandem operation, the management unit 32 manages status information obtained from the state monitoring unit 33 of the printer 10a (10b) and status information transferred from the state monitoring unit 33 of the downstream machine.

The management unit 32 further transmits the status information managed in the status information storage unit 35 via the SNMP communication unit 31 in accordance with an external status acquisition request transmitted from the high-level host device 30.

Further, upon receipt of an external status acquisition request, if the printer 10a (10b) is set as the downstream machine in tandem operation, the management unit 32 ignores the status acquisition request, and does not transmit status information. If the printer 10a (10b) is set as the upstream machine in tandem operation, the management unit 32 transmits the status information on the printer 10a (10b) and the status information on the downstream machine, which are managed, in accordance with the received status acquisition request.

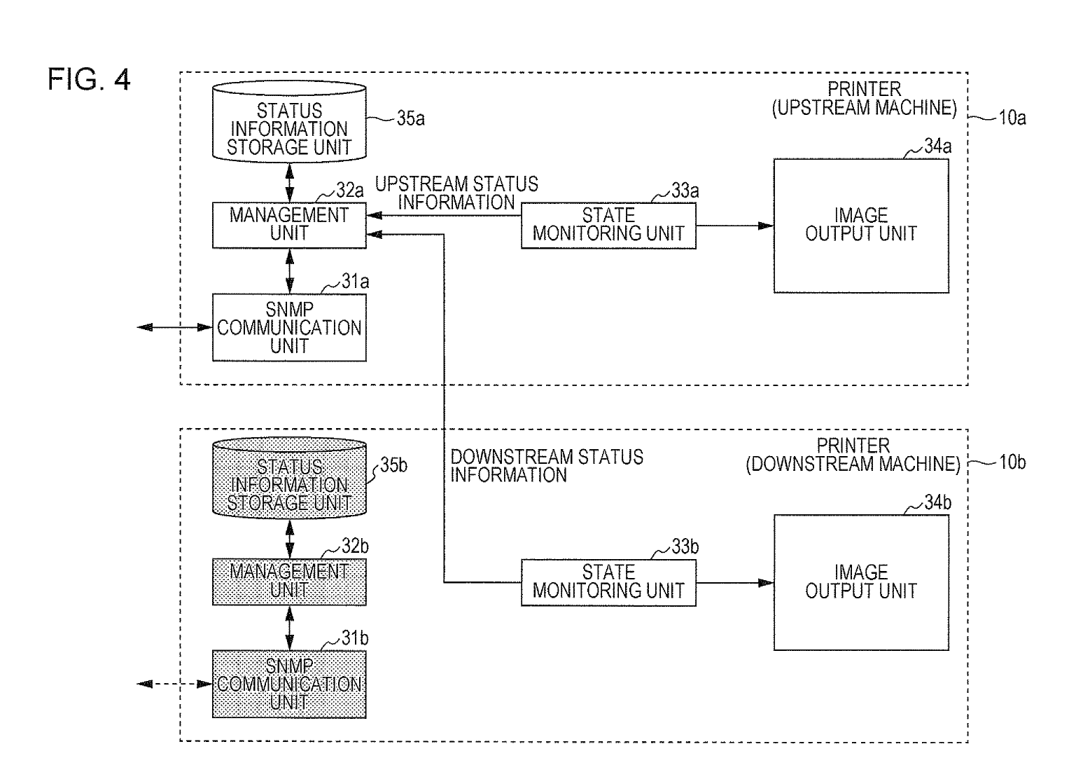

Next, the operation of the printers 10a and 10b in a case where the printer 10a operates as the upstream machine and the printer 10b operates as the downstream machine will be described with reference to a block diagram of FIG. 4.

In FIG. 4, for convenience of illustration, the printer 10a includes an SNMP communication unit 31a, a management unit 32a, a state monitoring unit 33a, an image output unit 34a, and a status information storage unit 35a, and the printer 10b includes an SNMP communication unit 31b, a management unit 32b, a state monitoring unit 33b, an image output unit 34b, and a status information storage unit 35b.

In the case as illustrated in FIG. 4, since the printer 10b is set as the downstream machine, the state monitoring unit 33b of the printer 10b transmits downstream status information indicating the operating state of the downstream machine to the management unit 32a of the printer 10a serving as the upstream machine. Then, the state monitoring unit 33a of the printer 10a serving as the upstream machine transmits the obtained status information to the management unit 32a of the printer 10a. In the printer 10b serving as the downstream machine, the state monitoring unit 33b may transmit the status information to the management unit 32a and the management unit 32b of the printer 10b.

Then, the management unit 32a stores upstream status information indicating the operating state of the printer 10a and the downstream status information transmitted from the downstream machine in the status information storage unit 35a for management. In the printer 10a serving as the upstream machine, when the SNMP communication unit 31a receives a status acquisition request from the high-level host device 30, the management unit 32a returns the managed upstream status information and downstream status information to the high-level host device 30 via the SNMP communication unit 31a.

In the printer 10b set as the downstream machine, even if the SNMP communication unit 31b receives a status acquisition request from the high-level host device 30, the management unit 32b ignores the status acquisition request and returns no reply. Thus, in the printer 10b set as the downstream machine, the SNMP communication unit 31b may be shut down and may remain inactive. Further, in a case where the status information obtained by the state monitoring unit 33b is transmitted to only the printer 10a serving as the upstream machine, the management unit 32b and the status information storage unit 35b may be rendered inactive.

Although not illustrated in FIG. 4, a print job sent from the high-level host device 30 is received by the printer 10a serving as the upstream machine, and reverse-side print data is transferred from the printer 10a to the printer 10b serving as the downstream machine. That is, the high-level host device 30 may only be required to communicate with the printer 10a serving as the upstream machine to instruct the tandem printing system to perform printing or manage operating states.

Next, the operation of the printing system according to this exemplary embodiment will be described in detail with reference to the drawings.

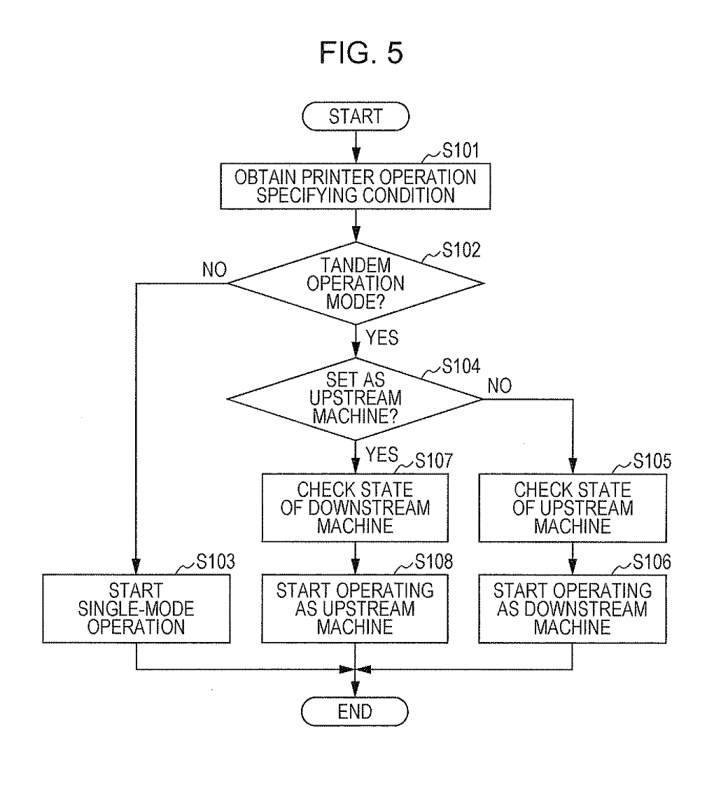

First, the initial setting operation of the printers 10a and 10b according to this exemplary embodiment will be described with reference to FIG. 5. Here, the operation of the printers 10a and 10b will be described in the context of the operation of a printer 10 unless otherwise noted.

First, the printer 10 obtains a printer operation specifying condition after power is turned on or after the system configuration is changed (step S101). Specifically, the printer 10 obtains information indicating whether the operation mode of the printer 10 is a single mode or a tandem mode and further obtains, if the operation mode is the tandem mode, information indicating whether the printer 10 is set as the upstream machine or the downstream machine.

If the operation mode is not the tandem mode (NO in step S102), that is, if the operation mode is the single mode, the printer 10 starts a single-mode operation (step S103).

If the operation mode is the tandem mode (YES in step S102), the printer 10 further determines whether or not the printer 10 is set as the upstream machine (step S104).

If the printer 10 is not set as the upstream machine, that is, if the printer 10 is set as the downstream machine (NO in step S104), the printer 10 checks with another printer, which is set as the upstream machine in the tandem system, about its state (step S105), and starts operating as the downstream machine if there is no configuration problem (step S106).

If the printer 10 is set as the upstream machine (YES in step S104), the printer 10 checks with another printer, which is set as the downstream machine in the tandem system, about its state (step S107), and starts operating as the upstream machine if there is no configuration problem (step S108).

In steps S105 and S107, it may be determined that there is a configuration problem, for example, when although the printer 10 has been set as the upstream machine, a printer that might have been set as the downstream machine is set as the upstream machine or the operation mode is the single mode.

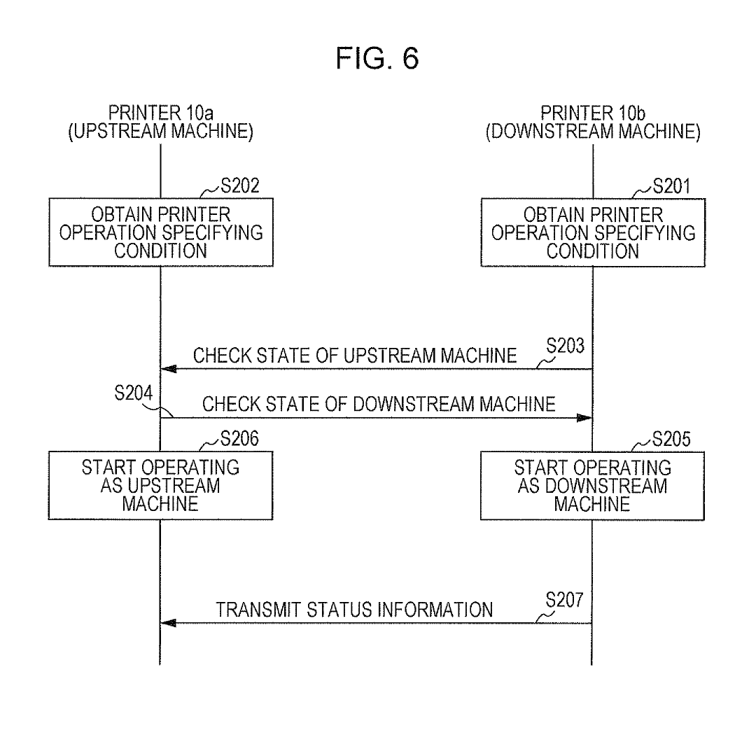

The above initial setting operation performed between the upstream machine and the downstream machine will be described with reference to a sequence chart of FIG. 6. In FIG. 6, a description will be given of a case where the printer 10a is set as the upstream machine, and the printer 10b is set as the downstream machine.

First, each of the printers 10a and 10b obtains a printer operation specifying condition (steps S201 and S202). Then, the printer 10b, which is set as the downstream machine, checks with the printer 10a serving as the upstream machine about its state (step S203). The printer 10a, which is set as the upstream machine, checks with the printer 10b serving as the downstream machine about its state (step S204).

Because each of the printers 10a and 10b has successfully confirmed the counterpart's state, the printer 10b starts operating as the downstream machine (step S205), and the printer 10a starts operating as the upstream machine (step S206).

Then, the state monitoring unit 33b of the printer 10b monitors the operating state of the image output unit 34b of the printer 10b, and transmits a monitoring result to the printer 10a as status information (step S207).

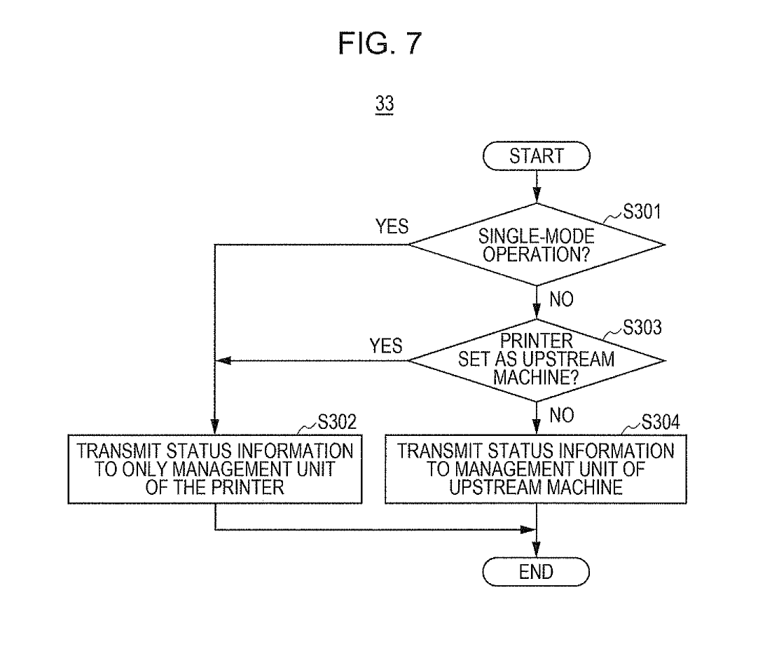

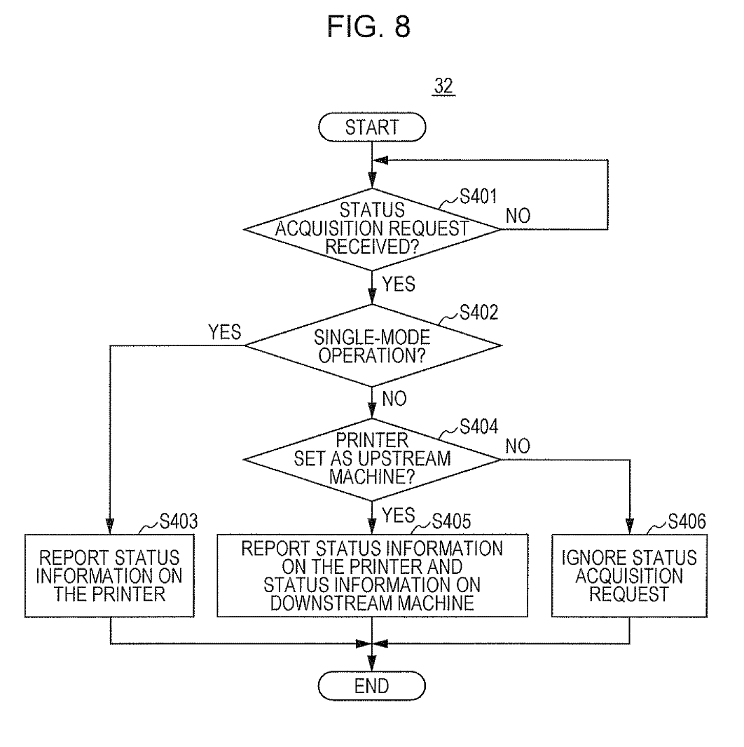

Next, the operation of the state monitoring unit 33 and the operation of the management unit 32 of the printer 10 during the normal operation will be described with reference to flowcharts of FIGS. 7 and 8, respectively.

First, the operation of the state monitoring unit 33 will be described with reference to a flowchart of FIG. 7.

If the operation mode of the operation mode of the printer 10 is the single mode (YES in step S301) or if the operation mode is the tandem mode (NO in step S301) but the printer 10 is set as the upstream machine (YES in step S303), the state monitoring unit 33 transmits status information to only the management unit 32 of the printer 10 (step S302).

If the operation mode is the tandem mode and the printer 10 is set as the downstream machine (NO in step S303), the state monitoring unit 33 transmits status information to the management unit 32 of the upstream machine (step S304). In this case, the state monitoring unit 33 may or may not transmit the status information to the management unit 32 of the printer 10.

Next, the operation of the management unit 32 will be described with reference to a flowchart of FIG. 8.

Upon receipt of a status acquisition request from the high-level host device 30 (step S401), the management unit 32 determines whether or not the operation mode of the printer 10 is the single mode (step S402).

If it is determined in step S402 that the operation mode is the single mode, the management unit 32 reports the status information on the printer 10, which is stored in the status information storage unit 35, to the high-level host device 30 through the SNMP communication unit 31 (step S403).

If it is determined in step S402 that the operation mode is the tandem mode, the management unit 32 further determines whether or not the printer 10 is set as the upstream machine (step S404). If the printer 10 is set as the upstream machine (YES in step S404), the management unit 32 reports the status information on the printer 10 and the status information on the downstream machine, which are stored in the status information storage unit 35, to the high-level host device 30 through the SNMP communication unit 31 (step S405).

If the printer 10 is set as the downstream machine (NO in step S404), the management unit 32 ignores the status acquisition request without returning a reply in response to the status acquisition request from the high-level host device 30 (step S406).

Next, a specific example of status information returned from the printer 10a serving as the upstream machine to the high-level host device 30 will be described.

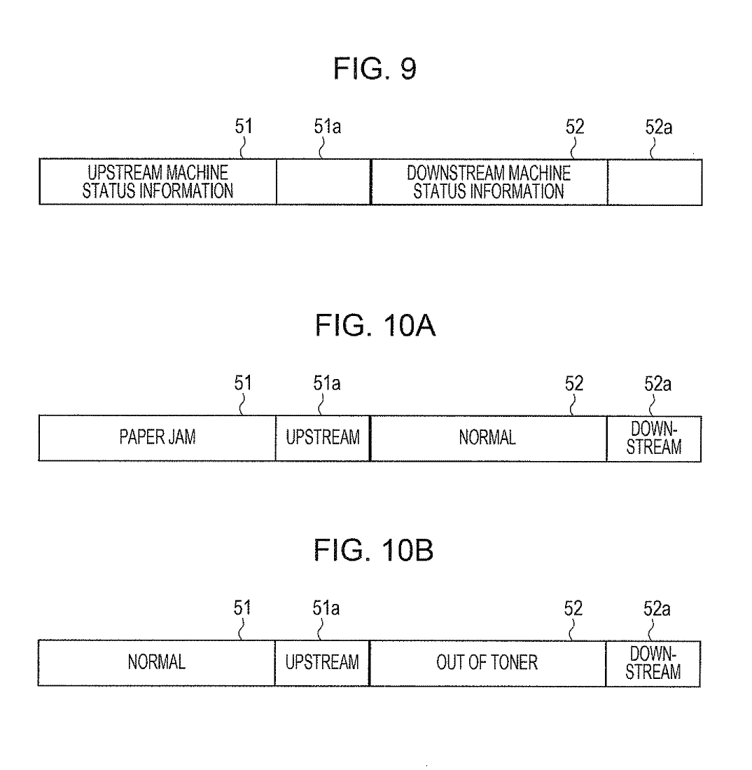

FIG. 9 illustrates the configuration of the status information on the printer 10a and the status information on the downstream machine which are returned to the high-level host device 30.

The status information includes upstream machine status information 51 indicating the operating state of the upstream machine, and downstream machine status information 52 indicating the operating state of the downstream machine. The upstream machine status information 51 and the downstream machine status information 52 are assigned identifiers 51a and 52a, respectively, each of which indicates whether the corresponding status information is information on the upstream machine or information on the downstream machine. The identifiers 51a and 52a may be identifiers called prtAlertGroupIndex, and may define which printers are the upstream machine and the downstream machine and also define single-mode status information or status information on the entire tandem system.

FIGS. 10A and 10B illustrate specific examples of the above status information. The status information illustrated in FIG. 10A indicates that “paper jam” has occurred in the upstream machine while the downstream machine is in “normal” operation. The status information illustrated in FIG. 10B indicates that the upstream machine is in “normal” operation while the downstream machine is running “out of toner”.

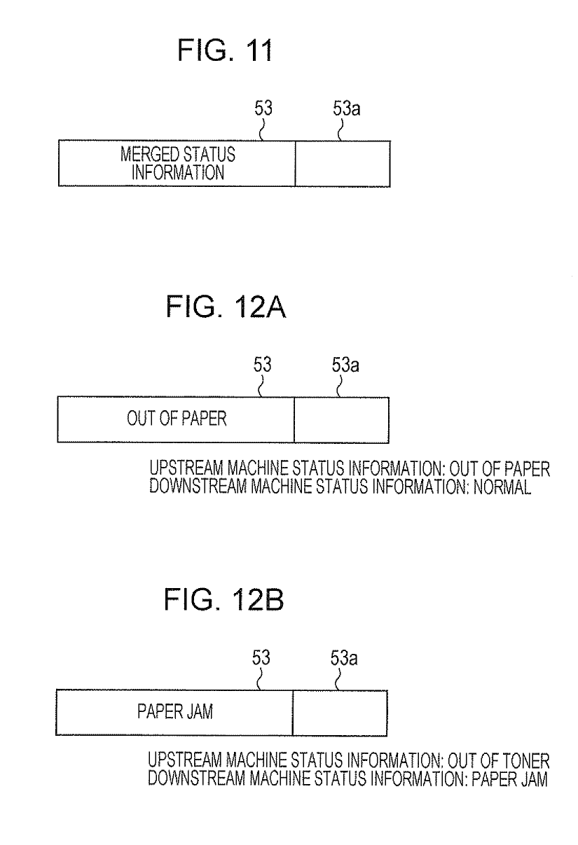

FIG. 11 illustrates another example of the status information. In the foregoing description, when the printer 10 is operating as the upstream machine, the management unit 32 returns both the status information on the printer 10 and the status information on the downstream machine to the high-level host device 30. Instead of the above, the management unit 32 may return only information with higher importance among the status information on the printer 10 and the status information on the downstream machine, which are managed, to the high-level host device 30. The status information illustrated in FIG. 11 illustrates the configuration of status information returned from the management unit 32 to the high-level host device 30 in the above case.

The status information includes merged status (combined operating state) information 53, and an identifier 53a indicating that the merged status information 53 is formed by combining two pieces of status information.

Here, the merged status information 53 may be information with higher importance, that is, more influential information, which is selected from among the operating state information on the upstream machine and the operating state information on the downstream machine.

For example, as illustrated in FIG. 12A, if the upstream machine status information indicates “out of paper” and the downstream machine status information indicates “normal”, the “out of paper” information which may be more influential is selected as the merged status information 53. Further, as illustrated in FIG. 12B, if the upstream machine status information indicates “out of toner” and the downstream machine status information indicates “paper jam”, the “paper jam” information which may be more influential is selected as the merged status information 53.

### Modifications

In the foregoing exemplary embodiment, a description has been given of a case where the upstream machine (printer 10a) transmits its status information and status information on the downstream machine (printer 10b) to the high-level host device 30. However, the present invention is not limited to this exemplary embodiment, and, in an exemplary embodiment, the downstream machine may obtain the status information on the upstream machine, and may transmit its status information and the status information on the upstream machine to the high-level host device 30. In this case, the downstream machine functions as the upper device, and the upstream machine functions as the lower device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printer comprising:
an output unit that outputs an image onto print paper;
a management unit that monitors an operating state of the output unit and that manages operating state information; and
a transmission unit that transmits operating state information managed by the management unit in response to an operating state acquisition request from a host device,
wherein upon receipt of a request for obtaining operating state information from the host device, if the printer is set as a first device in tandem operation, the transmission unit does not transmit the operating state information to the host device, and
if the printer is set as a second device in tandem operation, the transmission unit transmits operating state information on the printer and operating state information on the first device to the host device, the operating state information on the printer and the operating state information on the first device being managed by the management unit.

2. The printer according to claim 1, wherein if the printer is set as the second device in tandem operation, the management unit manages operating state information obtained by an obtaining unit included in the printer and operating state information transferred from an obtaining unit included in the first device, and
if the printer is set as the second device in tandem operation, the transmission unit transmits, in accordance with the operating state acquisition request, information with higher importance among the operating state information on the printer and the operating state information on the first device managed by the management unit.

3. The printer according to claim 1, wherein if the printer is set to perform a single-mode operation, the transmission unit transmits only the operating state information on the printer to the host device, the operating state information on the printer being managed by the management unit.

4. The printer according to claim 1, wherein the transmission unit transmits the operating state information as Management Information Base information based on Simple Network Management Protocol.

5. A computer readable medium storing a program causing a computer to execute a process comprising:
managing operating state information on a given device and operating state information on a first device in tandem operation if the given device is set as a second device in tandem operation; and
upon receipt of a request for obtaining operating state information from a host device, if the given device is set as the second device in tandem operation, transmitting the operating state information on the given device and the operating state information on the first device to the host device, the operating state information on the subject device and operating state information on the first device being managed.

6. A method comprising:
outputting an image onto print paper from a printer;
monitoring an operating state of the printer and managing operating state information; and
transmitting managed operating state information in response to an operating state acquisition request from a host device,
wherein when a request for obtaining operating state information is received from the host device, if the printer is set as a first device in tandem operation, the managed operating state information is not transmitted to the host device, and
if the printer is set as a second device in tandem operation, operating state information on the printer and operating state information on the first device are transmitted to the host device, the operating state information on the printer and the operating state information on the first device being managed.
